(19) United States
(12) Patent Application Publication
(10) Pub. No.: US 2026/0166731 A1
(43) Pub. Date: Jun. 18, 2026

(54) EXECUTION OF A ROBOT APPLICATION AND CREATION OF A PROGRAM THEREFOR

(71) Applicant: KUKA Deutschland GmbH, Augsburg (DE)

(72) Inventor: Shashank Sharma, Augsburg (DE)

(73) Assignee: KUKA Deutschland GmbH, Augsburg (DE)

(21) Appl. No.: 18/853,959

(22) PCT Filed: Mar. 3, 2023
(86) PCT No.: PCT/EP2023/055387

§ 371 Date: Oct. 3, 2024

(30) Foreign Application Priority Data
Apr. 6, 2022 (DE) 10 2022 203 406.6

(51) Int. Cl. B25J 9/16

(52) U.S. Cl. CPC B25J 9/1661; B25J 9/1664; B25J 9/1682

(57) ABSTRACT

A method for creating a program for executing a robot application that includes a plurality of actions of a first robot. The method includes recording programming inputs for programming actions of the first robot, and creating the program based on the recorded programming inputs. To create the program for different robots, in particular by a context, input names are uniformly specified and the programming inputs are interpreted based on of the input name used by the relevant programming input and the content determined for the input name by the relevant programming input, in particular by means of JSON-LD. Additionally or alternatively, at least one of the programming inputs includes at least one specification of a coordinate space, a specification of a control method of the first robot, a specification of a path of the first robot, a specification of a pose of the first robot, a specification of a tool action of the first robot, and/or a specification of a sensor type and/or action of the first robot.

### CROSS-REFERENCE TO RELATED APPLICATIONS

This application is a national phase application under 35 U.S.C. § 371 of International Patent Application No. PCT/EP2023/055387, filed Mar. 3, 2023 (pending), which claims the benefit of priority to German Patent Application No. DE 10 2022 203 406.6, filed Apr. 6, 2022, the disclosures of which are incorporated by reference herein in their entirety.

### TECHNICAL FIELD

The present invention relates to a method and system for creating a program for executing a robot application comprising a plurality of actions, in particular movements, of a first robot, in particular a method and system for executing the robot application, and to a computer program or computer program product for carrying out a method described herein.

### SUMMARY

In many robot applications, robots from different manufacturers are used, in particular robots from different manufacturers together, alternatively robots from different manufacturers or similar. These robots have to be programmed individually or specifically for each manufacturer.

However, JSON-LD, for example, is a known context-based data format or structure for the Internet that is particularly suitable as an interface between machines.

The object of the present invention is to improve the execution of robot applications or the creation of programs for this purpose.

This object is achieved by a method, a system, or a computer program or computer program product for carrying out a method as described herein.

According to one embodiment of the present disclosure, a robot application comprises a plurality of actions of a first robot.

In one embodiment, one or more of these actions each comprise one or more movements of the first robot, or may in particular be such movements. In one embodiment, the first robot and/or the further robot mentioned below comprise (in each case) a robot arm having at least three, in particular at least six joints, in one embodiment swivel joints.

According to one embodiment of the present disclosure, a method for creating a program for executing the robot application comprises the steps of:
recording programming inputs for programming the actions of the first robot; and
creating the program on the basis of these recorded programming inputs.

According to one embodiment of the present disclosure, input names or keys or a lexicon or vocabulary with input names or keys are uniformly specified for different robots, in particular different robot types and/or robots of different manufacturers, in one embodiment by a context specified in one embodiment, in a further embodiment by means of JSON-LD or a similar standard or data format or structure. For or when creating the program, the programming inputs are then (in each case) interpreted on the basis of
the input name of this input name or lexicon uniformly specified in one embodiment by the context, which is used by the relevant programming input, and
the content determined for this used input name by the relevant programming input, in particular a one- or multi-dimensional value,
in particular converted into machine-readable instructions of the program or for the first robot, in one embodiment by means of JSON-LD or a similar standard or data format or structure.

This allows the robot application to be advantageously programmed or executed for or with different robot(s) in one embodiment.

Additionally or alternatively, according to one embodiment of the present disclosure, one or more of the programming inputs comprise (respectively)
one or more specifications (each) of a coordinate space (for the first robot), in a further embodiment one or more selections (each) between one of a plurality of specified coordinate spaces, in one embodiment of a coordinate space for a movement input and/or a coordinate space for a pose of the first robot. In one embodiment, the specified coordinate spaces, in particular for a movement input and/or for a pose, comprise a joint coordinate space and/or one or more working spaces, in a further development an environment-fixed and/or an end-effector-fixed and/or a workpiece-fixed coordinate space; and/or
a specification of a control method of the first robot, in particular a selection between one of a plurality specified control methods, which in a further development comprise position control, velocity control and/or force control, in particular impedance control and/or admittance control, and/or a parameterization of the control method, which may be selected; and/or
a specification of a path of the first robot, in particular a selection between one of a plurality of specified path types, which in a further development comprise a point-to-point or PTP path, a circular segment or CIRC path, a straight line or LIN path, a spline or SPL path and/or one or more other path types, and/or a parameterization of the path (type), if selected; and/or
a specification, in particular parameterization, of a pose, in particular a target pose, of the first robot, in particular a selection between one of a plurality of specified coordinate spaces for the pose, which in a further development comprise a joint coordinate space and/or one or more working spaces, in a further development an environment-fixed and/or an end-effector-fixed and/or a workpiece-fixed coordinate space; and/or
a specification of a tool action of the first robot, in particular a selection between one of a plurality of specified tool actions and/or a parameterization of the tool action, which may be selected; and/or
a specification of a sensor type and/or action of the first robot, in particular a selection between one of a plurality of specified sensor types and/or actions, wherein in one embodiment the sensor is a sensor guided by the first robot.

These programming inputs, in particular a corresponding lexicon or a corresponding context that provides or makes them available, allow robot applications to be programmed or executed in a particularly simple, variable and/or reliable manner.

In one embodiment, the robot application comprises a plurality of actions of at least one further robot different from the first robot. In a further development, one or a plurality of these actions each comprise one or a plurality of movements of the further robot, or may in particular be such movements.

In one embodiment, the method comprises the steps of:
recording programming inputs for programming these actions of the further robot; and
creating the program on the basis of these recorded programming inputs.

In one embodiment, for or when creating the program, these programming inputs are interpreted for programming the actions of the further robot (in each case) on the basis of
the input name of the input names or lexicon uniformly specified in one embodiment by the context, which is used by the relevant programming input, and
the content determined for this input name used by the relevant programming input, in particular a one- or multi-dimensional value,
in particular converted into machine-readable instructions of the program or for the further robot, in an execution by means of JSON-LD or a similar standard or data format or structure.

This allows the robot application to be advantageously programmed or executed for a plurality of different robots in one embodiment.

Additionally or alternatively, in one embodiment, one or more of the programming inputs for programming the actions of the further robot comprise (respectively)
one or more specifications (each) of a coordinate space (for the further robot), in a further embodiment one or more selections (each) between one of a plurality of specified coordinate spaces, in one embodiment of a coordinate space for a movement input and/or a coordinate space for a pose of the further robot. In one embodiment, the specified coordinate spaces, in particular for a movement input and/or for a pose, comprise a joint coordinate space and/or one or more working spaces, in a further development an environment-fixed and/or an end-effector-fixed and/or a workpiece-fixed coordinate space; and/or
a specification of a control method of the further robot, in particular a selection between one of a plurality of specified control methods, which in a further development comprise position control, velocity control and/or force control, in particular impedance control and/or admittance control, and/or a parameterization of the control method, which may be selected; and/or
a specification of a path of the further robot, in particular a selection between one of a plurality of specified path types, which in a further development comprise a point-to-point or PTP path, a circular segment or CIRC path, a straight line or LIN path, a spline or SPL path and/or one or more other path types, and/or a parameterization of the path (type), if selected; and/or
a specification, in particular parameterization, of a pose, in particular a target pose, of the further robot, in particular a selection between one of a plurality of specified coordinate spaces for the pose, which in a further development comprise a joint coordinate space and/or one or more working spaces, in a further development an environment-fixed and/or an end-effector-fixed and/or a workpiece-fixed coordinate space; and/or
a specification of a tool action of the further robot, in particular a selection between one of a plurality of specified tool actions and/or a parameterization of the tool action, which may be selected; and/or
a specification of a sensor type and/or action of the further robot, in particular a selection between one of a plurality of specified sensor types and/or actions, wherein in one embodiment the sensor is a sensor guided by the first robot.

These programming inputs, in particular a corresponding lexicon or context that provides or makes them available, allow robot applications for a plurality of different robots to be programmed or executed in a particularly simple, variable and/or reliable manner.

In one embodiment, in a further development, the input names are specified uniformly by means of the specification of a context, in one embodiment by means of the specification of a type within a specified context and/or by means of JSON-LD.

As a result, different contexts or different types within a specified context can be accessed advantageously or alternatively in one embodiment or, with JSON-LD, a globally available and well-structured standard or data format can be used. This means that robot applications can be programmed or executed in one embodiment in a particularly variable and/or reliable manner.

In one embodiment, one or more of the programmed actions are implemented using a state machine when the program is created.

This allows branches (“IF . . . THEN . . . ”, “IF . . . ELSE . . . ” etc.) to be implemented advantageously in one embodiment.

According to one embodiment of the present disclosure, a method of executing the robot application comprises the steps of:
creating a program according to a method described herein; and
executing this created program using the first robot and, if necessary, the further robot.

According to one embodiment of the present disclosure, a system for creating the program for executing the robot application, in particular a system for executing the robot application, is configured in hardware and/or software, in particular program technology, for carrying out a method described herein and/or comprises:
means for recording programming inputs for programming these actions of the first robot; and
means for creating the program on the basis of these recorded programming inputs.

According to one embodiment of the present disclosure, for creating the program for different robots, in one embodiment by a context, input names are specified uniformly and the means for creating the program comprises means for interpreting the programming inputs on the basis of the input name used by the relevant programming input and the content determined for this used input name by the relevant programming input, in particular by means of JSON-LD.

Additionally or alternatively, according to one embodiment of the present disclosure, at least one of the programming inputs comprises at least one specification of a coordinate space (for the first robot), in particular at least one selection between one of a plurality of specified coordinate spaces, a specification of a control method of the first robot, in particular a selection between one of a plurality of specified control methods, a specification of a path of the first robot, in particular a selection between one of a plurality of specified path types, a specification of a pose of the first robot, in particular a selection between one of a plurality of specified coordinate spaces for the pose, a specification of a tool action of the first robot, in particular a selection between one of a plurality of specified tool actions, and/or a specification of a sensor type and/or action of the first robot, in particular a selection between one of a plurality of specified sensor types and/or actions.

In one embodiment, the robot application comprises a plurality of actions, in particular movements, of at least one further robot different from the first robot and the system or means thereof comprise:
means for recording programming inputs for programming these actions of the further robot; and
means for creating the program on the basis of these recorded programming inputs.

In one embodiment, the means for creating the program comprises means for interpreting these programming inputs for programming the actions of the further robot on the basis of the input name used by the relevant programming input, which in one embodiment is uniformly specified by the context, and the content determined for this used input name by the relevant programming input, in particular by means of JSON-LD.

Additionally or alternatively, according to one embodiment of the present disclosure, at least one of the programming inputs for programming the actions of the further robot comprises at least one specification of a coordinate space (for the further robot), in particular at least one selection between one of a plurality of specified coordinate spaces, a specification of a control method of the further robot, in particular a selection between one of a plurality of specified control methods, a specification of a path of the further robot, in particular a selection between one of a plurality of specified path types, a specification of a pose of the further robot, in particular a selection between one of a plurality of specified coordinate spaces for the pose, a specification of a tool action of the further robot, in particular a selection between one of a plurality of specified tool actions, and/or a specification of a sensor type and/or action of the further robot, in particular a selection between one of a plurality of specified sensor types and/or actions.

In one embodiment, the system or the means thereof comprises
means for uniformly specifying the input names by specifying a context, in particular by specifying a type within a specified context and/or by means of JSON-LD; and/or
means for implementing at least one of the programmed actions when creating the program by means of a state machine; and/or
means for executing the created program by means of the first robot and, if necessary, the further robot.

A system and/or a means in the sense of the present disclosure may be designed in hardware and/or in software, and in particular may comprise at least one, in particular digital, processing unit, in particular microprocessor unit (CPU), graphic card (GPU) or the like, which is preferably data-connected or signal-connected to a memory system and/or bus system, and/or one or multiple programs or program modules. The processing unit may be designed to process commands that are implemented as a program stored in a memory system, to detect input signals from a data bus and/or to issue output signals to a data bus. A memory system may comprise one or more, in particular different, storage media, in particular optical, magnetic, solid-state, and/or other non-volatile media. The program may be such that it embodies or is capable of executing the methods described herein, so that the processing unit can perform the steps of such methods and thus, in particular, create or execute the program. In one embodiment, a computer program product may comprise, in particular be, an, in particular computer-readable and/or non-volatile, storage medium for storing a program or instructions or with a program stored thereon or with instructions stored thereon. In one embodiment, executing said program or instructions by a system or computer, or an arrangement of a plurality of computers, causes the system or computer(s) to carry out a method or one or more steps thereof as described herein, or the program or instructions are arranged to do so.

In one embodiment, one or more, in particular all, steps of the method are performed completely or partially automatically, in particular by the system or its means.

In one embodiment, the system comprises the first robot and possibly also the further robot.

The present disclosure is explained with reference to JSON-LD, as this is a known and advantageous standard or data format or structure, but is in no way limited thereto.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 schematically illustrates a system for executing a robot application according to one embodiment of the present disclosure;

FIG. 2 illustrates a method of executing the robot application according to one embodiment of the present disclosure; and

FIGS. 3 and 4 illustrate programming input structures.

### DETAILED DESCRIPTION

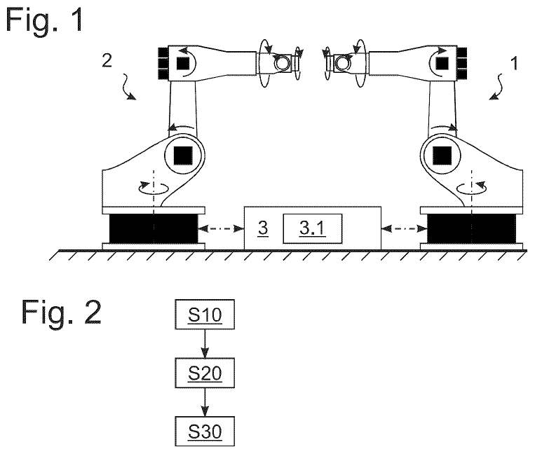

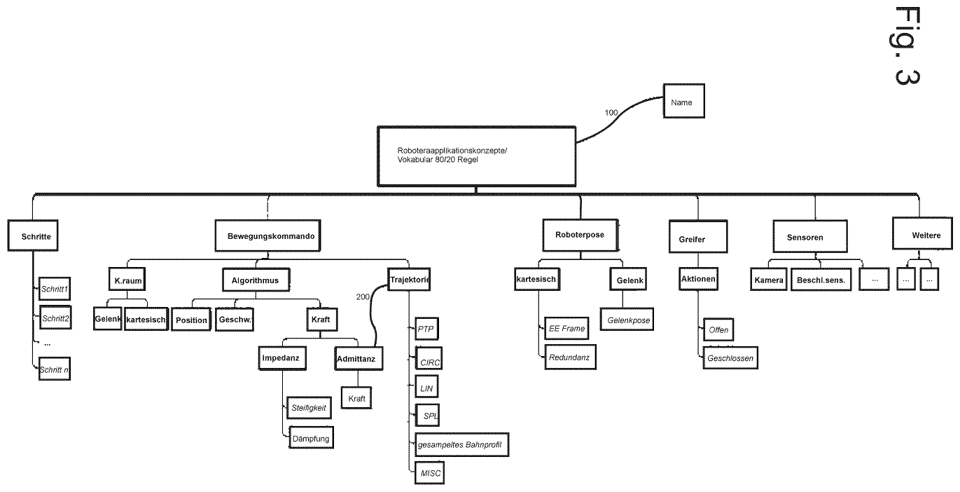

FIG. 1 shows a system for executing a robot application by means of a first robot 1 and, in a further development, an optional further robot 2, which are controlled by a centralized or decentralized or distributed controller 3, which executes a created program and comprises a means 3.1 for creating the program, which, as mentioned, can also be implemented decentrally, in particular by a dedicated computer with software running thereon, a cloud or the like, FIG. 2 shows a method for executing the robot application.

In a first step S10, programming inputs for programming actions of the first robot and, if necessary, also of the further robot are recorded.

In a second step S20, a program for executing a robot application is created on the basis of these recorded programming inputs.

In a third step S30, the created program is executed using the first robot and, if necessary, also the further robot.

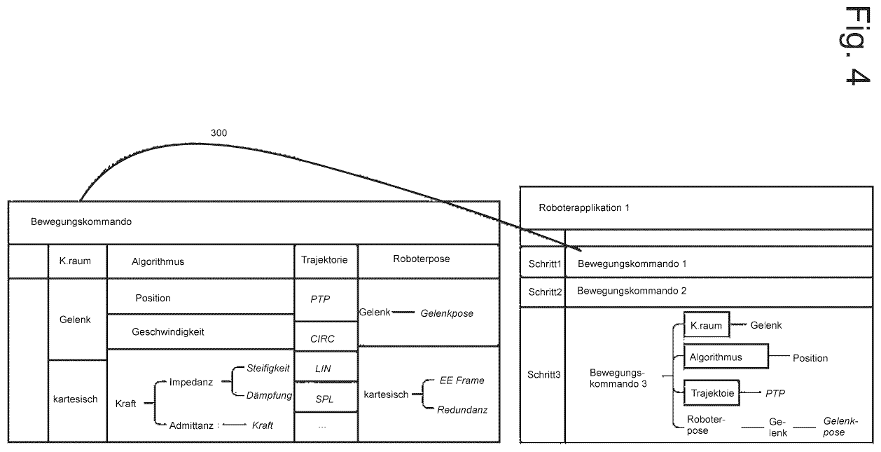

FIG. 3, 4 illustrate programming input structures.

The programming inputs can comprise the following as examples:

# JSON-LD for Robot Application 1
{
“@context”: “https://schema.org”,
“@type”: “Robot Application”
“name”: “Robot Application 1“,
,,step 1“: ,,Motion Command 1“,
,,step 2“: ,,Motion Command 2“,
...
}
or
# JSON-LD für Roboterapplikation 1
{
“@context”: “https://schema.org”,
“@type”: “Roboterapplikation”
“name”: “Roboterapplikation 1“,
,,Schritt 1“: ,,Bewegungskommando 1“,
,,Schritt 2“: ,,Bewegungskommando 2“,
...
}
or
# JSON-LD for Robotererapplikation 1
{
“@context”: “https://schema.org”,
“@type”: “Robot application”
“name”: “Roboterapplikation 1“,
,,step 1“: ,,Bewegungskommando 1“,
,,step 2“: ,,Bewegungskommando 2“,
...
}
or the like.

A context is indicated by “@context”: “https://schema.org”, wherein schema.org provides a standardized ontology for structuring data on websites based on existing markup languages as an example, and a type within the context is indicated by “@type”: “Robot Application” or “@type”: “Roboterapplikation”, which can be generated or modified, in particular extended, if necessary, especially in such a manner that it provides the programming inputs mentioned here.

As can be seen from FIGS. 3, 4, programming inputs may comprise motion commands with a choice between one of a plurality of specified coordinate spaces (“K.raum” or “Coordinate space”: “Gelenk” or “Joint”, “kartesisch” or “Cartesian”), a selection between one of several specified control methods (“Algorithmus” or “Range/Algorithm”: “Position”, “Geschwindigkeit” or “Velocity”, “Kraft-Impedanz” or “Force Impedance”, “Kraft-Admittanz” or “Force Admittance”), a parameterization of the (selected) control method (“Steifigkeit” or “Stiffness”, “Dämpfung” or “Damping”, “Kraft” or “Force”), a selection between one of a plurality of specified path types (“Trajektorie” or “Trajectory”: “PTP”, “CIRC”, “LIN”, “SPL”, “gesampeltes Bahnprofil” or “Sampled Path Profile”, “MISC”) or their parameterization, robot poses (“Roboterpose” or “Robot Pose”), in particular by selecting between one of a plurality of specified coordinate spaces (“Gelenk” or “Joint”, “kartesisch” or “Cartesian”) for the pose and its parameterization (“Gelenkpose” or “Joint pose”, “EE Frame”, “Redundanz” or “Redundancy”), tool actions (“Greifer” or “Gripper”: “Aktionen” or “Actions”) or their parameterization (“Offen” or “Open”, “Geschlossen” or “Close”), sensor types and/or actions (“Sensoren” or “Sensors”: “Kamera” or “Camera”, “Beschleunigungsmesser” or “Accelerometer”, “ . . . ”) and other elements (“Weitere” or “Other”). The corresponding contents (“Steifigkeit” or “Stiffness”, “Dämpfung” or “Damping”, “Kraft” or “Force”, “EE Frame”, “Redundanz” or “Redundancy”, “Gelenkpose” or “Joint Pose”, “Offen” or “Open”, “Geschlossen” or “Close”) are determined by the relevant programming input.

As illustrated in FIG. 4, as step 3 of the program, for example, a motion command can be recorded or implemented that comprises a position-controlled PTP path in joint angle space to a target pose that is specified in joint angle space by the values “joint pose” (or “Gelenkpose”). This is indicated in FIG. 4 by a line with the reference sign 300, which is to be understood as “is of type” or depicts this. Analogously, in FIG. 3 the reference sign 100 is to be understood as “hat Namen” or “has Name” and the reference sign 200 as “hat nicht” or “does not have” or depicts this.

The JSON-LD data model depicts an extension or serialization of the RDF model. Thus, in one embodiment, the robot application can be represented in an RDF graph and then serialized to JSON-LD. An RDF serialization in N-QUADS serialization would be, for example:
_:b0<http://schema.org/name> “Robot Application 1”.
. . .
or
_:b0<http://schema.org/name> “Roboterapplikation 1”.

Although exemplary embodiments have been explained in the preceding description, it is pointed out that a large number of modifications is possible. In particular, English-language terms have been recited above, as these are (more) commonly used in robotic applications. It is also pointed out that the exemplary embodiments are merely examples that are not intended to restrict the scope of protection, the applications, and the structure in any way. Rather, the preceding description provides a person skilled in the art with guidelines for implementing at least one exemplary embodiment, with various changes, in particular with regard to the function and arrangement of the described components, being able to be made without departing from the scope of protection as it arises from the claims and from these equivalent combinations of features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

1 first robot
2 further robot
3 controller
3.1 means for creating a program
100 “hat Namen” (“has Name”)
200 “hat nicht” (“does not have”)
300 “ist vom Typ” (“is of type”)

What is claimed is:

1-13. (canceled)

14. A method for creating a program for executing a robot application that includes a plurality of actions of a first robot, the method comprising:
recording programming inputs for programming the actions of the first robot; and
creating the program based on the recorded programming inputs;
wherein, for creating the program for different robots, at least one of:
input names are specified uniformly and the programming inputs are interpreted on the basis of the input name used by the relevant programming input and the content determined for the used input name, or
at least one of the programming inputs comprises at least one of:
at least one specification of a coordinate space,
a specification of a control method of the first robot,
a specification of a path of the first robot,
a specification of a pose of the first robot,
a specification of a tool action of the first robot, or
a specification of at least one of a sensor type or action of the first robot.

15. The method of claim 14, wherein at least one of:
the actions of the first robot are movements of the first robot;
input names are specified based on context;
input names are specified using JavaScript Object Notation for Linked Data (JSON-LD);
the at least one specification of a coordinate space is at least one selection between one of a plurality of specified coordinate spaces;
the specification of a control method of the first robot is a selection between one of a plurality of specified control methods;
the specification of a path of the first robot is a selection between one of a plurality of specified path types;
the specification of a pose of the first robot is a selection between one of a plurality of specified coordinate spaces for the pose;
the specification of a tool action of the first robot is a selection between one of a plurality of specified tool actions; or
the specification of at least one of a sensor type or action of the first robot is a selection between one of a plurality of specified sensor types or actions.

16. The method of claim 14, wherein the robot application includes a plurality of actions of at least one second robot different from the first robot, the method further comprising:
recording second programming inputs for programming the actions of the second robot; and
creating the program based on the recorded second programming inputs;
wherein at least one of:
input names are specified uniformly and the second programming inputs are interpreted on the basis of the input name used by the relevant second programming input and the content determined for the used input name, or
at least one of the programming inputs comprises at least one of:
at least one specification of a coordinate space,
a specification of a control method of the first robot,
a specification of a path of the first robot,
a specification of a pose of the first robot,
a specification of a tool action of the first robot, or
a specification of at least one of a sensor type or action of the first robot.

17. The method of claim 16, wherein at least one of:
the actions of the second robot are movements of the second robot;
input names are specified based on context;
input names are specified using JavaScript Object Notation for Linked Data (JSON-LD);
the at least one specification of a coordinate space is at least one selection between one of a plurality of specified coordinate spaces;
the specification of a control method of the second robot is a selection between one of a plurality of specified control methods;
the specification of a path of the second robot is a selection between one of a plurality of specified path types;
the specification of a pose of the second robot is a selection between one of a plurality of specified coordinate spaces for the pose;
the specification of a tool action of the second robot is a selection between one of a plurality of specified tool actions; or
the specification of at least one of a sensor type or action of the second robot is a selection between one of a plurality of specified sensor types or actions.

18. The method of claim 14, wherein input names are uniformly specified by at least one of:
specifying a type within a specified context; or
using JSON-LD.

19. The method of claim 14, wherein, when the program is created, at least one of the programmed actions is implemented using a state machine.

20. A method for executing a robot application that includes a plurality of actions of a first robot, the method comprising:
creating a program according to the method of claim 14; and
executing the created program using at least the first robot.

21. The method of claim 20, wherein the actions of the first robot are movements of the first robot.

22. A system for creating a program for executing a robot application that includes a plurality of actions of a first robot, the system comprising:
means for recording programming inputs for programming the actions of the first robot; and
means creating the program based on the recorded programming inputs;
wherein, for creating the program for different robots, at least one of:
input names are specified uniformly and the programming inputs are interpreted on the basis of the input name used by the relevant programming input and the content determined for the used input name, or
at least one of the programming inputs comprises at least one of:
at least one specification of a coordinate space,
a specification of a control method of the first robot,
a specification of a path of the first robot,
a specification of a pose of the first robot,
a specification of a tool action of the first robot, or
a specification of at least one of a sensor type or action of the first robot.

23. The system of claim 22, wherein at least one of:
the actions of the first robot are movements of the first robot;
input names are specified based on context;
input names are specified using JavaScript Object Notation for Linked Data (JSON-LD);
the at least one specification of a coordinate space is at least one selection between one of a plurality of specified coordinate spaces;
the specification of a control method of the first robot is a selection between one of a plurality of specified control methods;
the specification of a path of the first robot is a selection between one of a plurality of specified path types;
the specification of a pose of the first robot is a selection between one of a plurality of specified coordinate spaces for the pose;
the specification of a tool action of the first robot is a selection between one of a plurality of specified tool actions; or
the specification of at least one of a sensor type or action of the first robot is a selection between one of a plurality of specified sensor types or actions.

24. A computer program product comprising program code stored on a non-transient, computer-readable medium, the program code, when executed by a computer, causing the computer to carry out the method of claim 14.
